(19) United States
(12) Patent Application Publication
(10) Pub. No.: US 2006/0169082 A1
(43) Pub. Date: Aug. 3, 2006

(54) Shaft assembly

(75) Inventor: Weldon H. Clark JR., Liberty, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 11/035,541

(22) Filed: Jan. 14, 2005

(51) Int. Cl. F16H 1/20

(52) U.S. Cl. 74/425; 74/421 A

(57) ABSTRACT

A shaft assembly comprises a first shaft and a second shaft. The first shaft has a first end, a second end, and a diametric shoulder. The diametric shoulder is located between the first end and the second end along a first central axis of the first shaft. The second end has at least one axial spline. The second shaft is coupled with the first shaft and has a first end and a second end. The first end of the second shaft has a bore along a second central axis of the second shaft with at least one axial groove. The at least one axial spline is positioned within the at least one axial groove and the diametric shoulder is positioned within the bore.

### TECHNICAL FIELD

The present invention relates to a shaft assembly, and more particularly relates to a shaft assembly that couples an output shaft of a motor to a secondary shaft having a worm.

### BACKGROUND

Motors may be used to drive various mechanical devices. For example, in the power tools industry, a motor may be used to drive a saw. In one motor assembly design, the output shaft of such a motor includes a portion which extends beyond the end of the motor case. A worm is mounted to the shaft portion and engages a worm gear to ultimately drive the saw blade. However, in order to smoothly transmit the drive torque generated by the motor through the gears to the saw blade, the output shaft of the motor must be supported. In addition, the gears must be coupled to the output shaft of the motor in some manner.

One approach for supporting the output shaft of a motor having a worm coupled to a worm gear is to support the output shaft at two points within the motor case with bearings. This cantilevers the worm on the output shaft into engagement with the worm gear. However, the worm tends to bend away from the worm gear during operation of the motor. This causes the teeth of the worm to separate from the teeth of the worm gear, possibly resulting in damage to both gears.

FIG. 1 illustrates another approach for supporting the output shaft. In addition to supporting the output shaft 100 at two points about the motor 102 with bearings 110, 112, a third bearing 114 is added to support the end of the output shaft 100 near the worm 120. However, when a single solid shaft is supported by three bearings, it is difficult to precisely align all three bearings so that they share the same axis of rotation, especially as the output shaft experiences uneven stresses along its length. As a result, at least one of the bearings tends to bind with the shaft due to this misalignment, resulting in reduced performance and possible failure of the assembly.

One approach, disclosed in U.S. Pat. No. 5,716,279 to Ham, attempts to address this binding problem caused by three bearings on a single shaft by using a ball joint to couple an output shaft to a secondary shaft. Ham then supports a first end of the output shaft and both ends of the secondary shaft with ball bearings. While this flexible coupling allows for a shaft misalignment between the output shaft and the secondary shaft, it also allows the output shaft to flex before the coupling. This flexibility decreases the stiffness of the coupled shaft assembly, which in turn decreases the natural frequency of the assembly and makes it more difficult to rotationally balance the shaft assembly. With a lower natural frequency, it may be possible for the motor to rotate the shaft assembly at a speed which resonates with the natural frequency, causing increased vibration. Similarly, an unbalanced shaft assembly increases vibration. Increased vibration may result in increased noise, decreased power transmission, and increased wear of the moving parts.

For the foregoing reasons, there is a need for a rigid shaft assembly that reduces the need for accurately aligning three bearings on a single shaft while providing for a design with an increased natural frequency.

### BRIEF SUMMARY

Accordingly, embodiments of the present invention provide a new and improved shaft assembly. In one embodiment, an output shaft is coupled with a secondary shaft. The output shaft has a diametric shoulder and at least one axial spline at one end. The secondary shaft has a bore having at least one axial groove at one end. The diametric shoulder is positioned within the bore to collinearly align and locate the output shaft with the secondary shaft. The at least one axial spline is then positioned within the at least one axial groove so that the at least one axial spline rotationally engages the at least one axial groove, transmitting a motor torque from the output shaft to the secondary shaft. Bearings are positioned at both ends of the output shaft, and at the second end of the secondary shaft. This shaft coupling design provides for a rigid armature design that eliminates the need for three bearings on a single shaft.

According to a first aspect of the invention, a shaft assembly comprises a first shaft and a second shaft. The first shaft has a first end, a second end, and a diametric shoulder. The diametric shoulder is located between the first end and the second end along a first central axis of the first shaft. The second end has at least one axial spline. The second shaft is coupled with the first shaft and has a first end and a second end. The first end of the second shaft has a bore along a second central axis of the second shaft with at least one axial groove. The axial spline is positioned within the axial groove and the diametric shoulder is positioned within the bore.

According to a second aspect of the invention, a motor assembly comprises a motor, a first shaft, a second shaft, a first bearing, a second bearing, and a third bearing. The first shaft is driven by the motor and has a first end, a second end, and a diametric shoulder. The diametric shoulder is located between the first end and the second end along a first central axis of the first shaft. The second end has at least one axial spline. The second shaft is coupled with the first shaft and has a first end and a second end. The first end of the second shaft has a bore along a second central axis of the second shaft with at least one axial groove. The axial spline is positioned within the axial groove and the diametric shoulder is positioned within the bore. The first bearing supports the first end of the first shaft. The second bearing supports the second end of the first shaft. The third bearing supports the second end of the second shaft.

A third aspect of the invention is a method of transferring torque from a motor to a rotary output. The method includes the step of providing a first shaft having a first end, a second end, and a diametric shoulder. The diametric shoulder is located between the first end and the second end along a first central axis of the first shaft. The second end also has at least one axial spline. The method also includes the step of providing a second shaft coupled with the first shaft. The second shaft has a first end and a second end. The first end of the second shaft has a bore along a second central axis of the second shaft with at least one axial groove. The method also includes the step of positioning the diametric shoulder within the bore so that the first central axis is substantially collinearly aligned with the second central axis. The method also includes the step of positioning the axial spline within the axial groove so that the axial spline rotationally engages the at least one axial groove.

### BRIEF DESCRIPTION OF THE DRAWINGS

FIG. 1 shows a cross section view of a prior art motor assembly design placing three bearings on a single solid shaft.

FIG. 2 shows a cross section view of a motor assembly that incorporates the shaft assembly of the present invention.

FIG. 3 is a perspective view of the shaft assembly of the present invention.

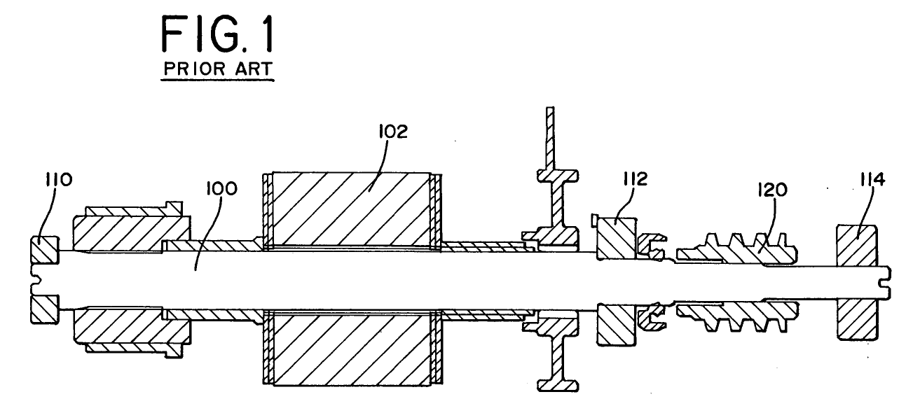

### DETAILED DESCRIPTION OF THE DRAWINGS AND THE PRESENTLY PREFERRED EMBODIMENTS

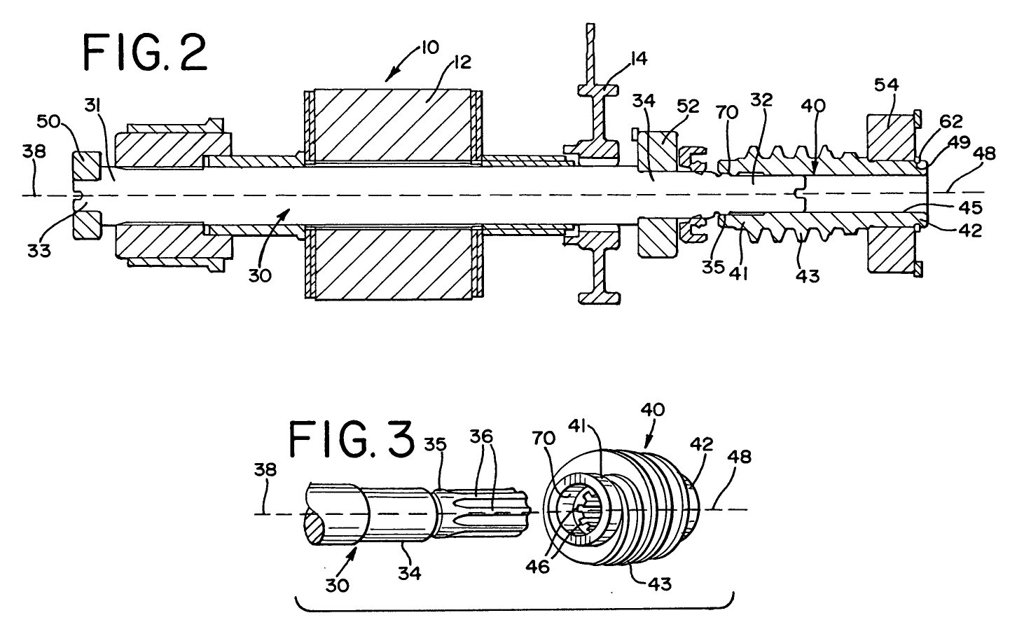

Referring now to FIG. 2, a cross section of a motor assembly 10 is shown. The motor assembly 10 includes a motor 12, a cooling fan 14, an armature drive shaft 30, a secondary shaft 40, and bearings 50, 52, 54. The drive shaft 30 may be made from AISI 4140 or SCM 440 steel, although other materials may be used. Drive shaft 30 is an armature shaft that is rotated about a first central axis 38 during operation of the motor 12.

Drive shaft 30 has a first end 31 and a second end 32. First end 31 has a first stepped portion 33. Second end 32 also has a second stepped portion 34. The second stepped portion 34 transitions to a narrow diametric shoulder 35 along central axis 38. The diametric shoulder 35 then transitions to at least one axial spline 36 at second end 32. The embodiment shown in FIGS. 2 and 3 illustrates the second end 32 as having eight axial splines 36, although other numbers of splines may be used. The axial spline may be straight or helical in shape.

FIG. 2 illustrates drive shaft 30 coupled with secondary shaft 40. As seen in FIGS. 2 and 3, secondary shaft 40 has an integral worm 43. Secondary shaft 40 is preferably machined from AISI 1144 steel, then case hardened to extend wear, although other materials may be used. The worm 43 engages a worm gear (not shown) to transfer torque from the motor 12 through the output shaft 30 and secondary shaft 40 to the worm gear. The worm gear may be coupled to a mechanical system (not shown) which ultimately is used to rotate a saw blade or other rotary output.

Secondary shaft 40 has a first end 41 and a second end 42 aligned along a second central axis 48. A bore 45 extends through secondary shaft 40 along central axis 48. As can be seen in FIG. 3, secondary shaft 40 has at least one internal axial groove 46 at first end 41 which receives the spline 36 on drive shaft 30. The embodiment shown in FIGS. 2 and 3 has eight grooves 46, although other numbers of grooves may also be used. The bore 45 has a circumferential portion 70 with a smaller diameter at the first end 41 of the secondary shaft 40 to support the diametric shoulder 35.

The circumferential portion 70 of bore 45 and diametric shoulder 35 are dimensioned to create a very close clearance when drive shaft 30 is coupled with secondary shaft 40. This close clearance between diametric shoulder 35 and circumferential portion 70 of bore 45 substantially aligns the first central axis 38 of drive shaft 30 with the second central axis 48 of secondary shaft 40. For example, for drive shaft 30 having a nominal outer diameter of 15 mm, the diametric shoulder 35 may be dimensioned as a 1.50 mm wide by 10.345 mm to 10.356 mm diameter shoulder. The circumferential portion 70 of the bore 45 has a corresponding inner diameter of 10.3784 mm to 10.3556 mm. In addition, in the embodiment illustrated in FIG. 3, the outer diameter of second stepped portion 34 is larger than bore 45 to limit the axial insertion of drive shaft 30 into secondary shaft 40. For example, for the drive shaft 30 with a nominal outer diameter of 15 mm, second stepped portion 34 may have an outer diameter of 10.80 mm, while the diametric shoulder 35 may have an outer diameter of only 10.35 mm.

The rotational engagement between the splines 36 of drive shaft 30 and the grooves 46 of the secondary shaft 40 allow for torque to be transmitted from the motor 12 through the drive shaft 30 and to the secondary shaft 40. However, the spline and groove interface is preferably dimensioned with a very loose fit so that the engagement between the spline 36 and the groove 46 does not align the drive shaft 30 with secondary shaft 40. For example, for the drive shaft 30 with a nominal outer diameter of 15 mm, the splines 36 may have a nominal outer diameter of 0.3750 in., with a nominal root diameter of 0.2475 in. The grooves 46 of secondary shaft 40 may have a corresponding nominal inner diameter of 0.2998 inches, with a nominal root diameter of 0.3921 inches, although other sizes may be used.

The motor assembly 10 is supported by a first bearing 50, a second bearing 52 and a third bearing 54. The first bearing 50 supports the first end 31 of drive shaft 30, while the second bearing 52 supports the second end 32 of the drive shaft 30. The third bearing 54 supports the second end 42 of the secondary shaft 40. First bearing 50 is positioned on first stepped portion 33 of drive shaft 30, while second bearing 52 is placed on second stepped portion 34 of drive shaft 30. Bearings 50 and 52 are both press fit onto drive shaft 30. A retaining ring 62 is placed into a circumferential groove 49 on secondary shaft 40 to hold third bearing 54 in place on drive shaft 40. For example, bearings 50, 52, 54 may be ball or roller bearings available from NTN BEARING CORPORATION OF AMERICA. For the sample dimensions of drive shaft 30 and secondary shaft 40 described above, a ball bearing with NTN part number 608 may be used for first bearing 50, having an inner diameter of 8 mm, an outer diameter of 22 mm, and a thickness of 7 mm. Similarly, a ball bearing with NTN part number 6201 may be used for second bearing 52, having an inner diameter of 12 mm, an outer diameter of 32 mm, and a thickness of 10 mm. Third bearing 54 may use a ball bearing with NTN part number 6203, having an inner diameter of 17 mm, an outer diameter of 40 mm, and a thickness of 12 mm. However, other types of bearings, bearing suppliers, or bearings with different sizes may be used.

In operation, as the motor 12 drives the drive shaft 30 about first central axis 38, torque is transmitted from the drive shaft 30 through the spline 36 and groove 46 engagement to secondary shaft 40 and worm 43. Fan 14, coupled with drive shaft 30, forces air over motor 12 to provide cooling as drive shaft 30 rotates. Worm 43 engages a worm gear, which in turn drives an output such as a saw blade. The interface between diametric shoulder 35 and the circumferential portion 70 of the bore 45 substantially collinearly aligns the first central axis 38 of drive shaft 30 with the second central axis 48 of secondary shaft 40, while the engagement between the splines 36 and grooves 46 transmit torque from the drive shaft 30 to the secondary shaft 40. By placing bearing supports 50, 52, 54 at both ends 31, 32 of drive shaft 30 and at the second end 42 of secondary shaft 40, a rigid coupling with a high natural frequency is established that reduces the alignment concerns and binding associated with placing three bearings on a single shaft.

While the invention has been described with reference to details of the illustrated embodiment, these details are not intended to limit the scope of the invention as defined in the appended claims. For example, while the present invention has been described for use with power tools having worm drives, such as a saw, the present invention may be used with any motor assembly having a shaft assembly. Other outputs or gears, such as spur or bevel gears, may be used in place of the worm. Also, means for rotational engagement other than splines and grooves may be used such as keys and keyways, for example. Alternately, the splines or keys may be formed on the secondary shaft, with the drive shaft having the corresponding grooves or keyways. In addition, the diametric shoulder and corresponding bore may be sized or shaped differently. It is therefore intended that the foregoing detailed description be regarded as illustrative rather than limiting, and that it be understood that it is the following claims, including all equivalents, that are intended to define the spirit and scope of this invention.

We claim:

1. A shaft assembly comprising:
a first shaft having a first end, a second end, and a diametric shoulder, wherein the diametric shoulder is located between the first end and the second end along a first central axis of the first shaft, and wherein the second end has at least one axial spline; and
a second shaft coupled with the first shaft and having a first end and a second end, wherein the first end of the second shaft has a bore along a second central axis of the second shaft with at least one axial groove, and wherein the at least one axial spline is positioned within the at least one axial groove and the diametric shoulder is positioned within the bore.

2. The shaft assembly of claim 1, wherein the diametric shoulder of the first shaft is cylindrical or spherical.

3. The shaft assembly of claim 1 further comprising:
a first bearing which supports the first end of the first shaft;
a second bearing which supports the second end of the first shaft; and
a third bearing which supports the second end of the second shaft.

4. The shaft assembly of claim 3, wherein a motor drives the first shaft.

5. The shaft assembly of claim 4, wherein the second shaft has an integral gear.

6. The shaft assembly of claim 5, wherein the integral gear is a worm.

7. The shaft assembly of claim 5, wherein the integral gear is a spur, helical, or other type of gear, pulley, or rotating device of any kind.

8. The shaft assembly of claim 4, wherein the second shaft has an integral pulley.

9. The shaft assembly of claim 1, wherein the at least one axial spline rotationally engages the at least one axial groove, and wherein the engagement between the diametric shoulder and the bore substantially aligns the first central axis collinearly with the second central axis.

10. A motor assembly comprising:
a motor;
a first shaft driven by the motor and having a first end, a second end, and a diametric shoulder, wherein the diametric shoulder is located between the first end and the second end along a first central axis of the first shaft, and wherein the second end has at least one axial spline;
a second shaft coupled with the first shaft and having a first end and a second end, wherein the first end of the second shaft has a bore along a second central axis of the second shaft with at least one axial groove, and wherein the at least one axial spline is positioned within the at least one axial groove and the diametric shoulder is positioned within the bore;
a first bearing which supports the first end of the first shaft;
a second bearing which supports the second end of the first shaft; and
a third bearing which supports the second end of the second shaft.

11. The shaft assembly of claim 10, wherein the second shaft has an integral gear.

12. The shaft assembly of claim 11, wherein the integral gear is a worm.

13. The shaft assembly of claim 10, wherein the at least one axial spline rotationally engages the at least one axial groove, and wherein the engagement between the diametric shoulder and the bore substantially aligns the first central axis collinearly with the second central axis.

14. A method of transferring torque from a motor to a rotary output, the method comprising the steps of:
providing a first shaft having a first end, a second end, and a diametric shoulder, wherein the diametric shoulder is located between the first end and the second end along a first central axis of the first shaft, and wherein the second end has at least one axial spline; and
providing a second shaft coupled with the first shaft and having a first end and a second end, wherein the first end of the second shaft has a bore along a second central axis of the second shaft with at least one axial groove;
positioning the diametric shoulder within the bore so that the first central axis is substantially collinearly aligned with the second central axis; and
positioning the at least one axial spline within the at least one axial groove so that the at least one axial spline rotationally engages the at least one axial groove.

15. The method of claim 14 further comprising the steps of:
supporting the first end of the first shaft with a first bearing;
supporting the second end of the first shaft with a second bearing; and
supporting the second end of the second shaft with a third bearing.

16. The method of claim 15, further comprising the steps of:
providing a motor; and
driving the first shaft with the motor.

17. The method of claim 16, wherein the second shaft has an integral gear.

18. The method of claim 17, wherein the integral gear is a worm.
